(19) United States
(12) Patent Application Publication
(10) Pub. No.: US 2015/0341634 A1
(43) Pub. Date: Nov. 26, 2015

(54) METHOD, APPARATUS AND SYSTEM TO SELECT AUDIO-VIDEO DATA FOR STREAMING

(71) Applicant: Intel Corporation, Santa Clara, CA (US)

(72) Inventor: Yong H. Jiang, Shanghai (CN)

(21) Appl. No.: 14/129,540

(22) PCT Filed: Oct. 16, 2013
(86) PCT No.: PCT/CN2013/085277

§ 371 Date: Dec. 26, 2013

(51) Int. Cl. H04N 19/103; H04N 19/157; H04N 19/136

(52) U.S. Cl. CPC H04N 19/103; H04N 19/136; H04N 19/157

(57) ABSTRACT

Techniques and mechanisms for processing portions of an audio-video data stream. In an embodiment, a device operates in a first mode to download via a network first data of an AV stream, the first data encoded according to a first coding scheme. Based on a current state of the network, the device may transition to a second mode to download second data of the AV stream which is encoded according to a second coding scheme. In another embodiment, only one of the first coding scheme and the second coding scheme supports a scalability feature. The device further evaluates the first downloaded data and the second downloaded data to determine whether other AV data is to be downloaded to mitigate a change in a quality of experience for a resulting AV display.

### BACKGROUND

1. Technical Field

This disclosure relates generally to network streaming and more particularly, but not exclusively, to determining a level of quality for audio-video data.

2. Background Art

Hypertext transfer protocol (HTTP) streaming is spreading widely as a form of multimedia delivery over networks such as the Internet. HTTP-based delivery provides reliable and simple deployment due to the already broad adoption of both HTTP and its underlying Transmission Control Protocol/Internet Protocol (TCP/IP) protocols. Moreover, HTTP-based delivery enables effortless streaming services by avoiding network address translation (NAT) and firewall traversal issues. HTTP-based streaming also provides the ability to use standard HTTP servers and caches instead of specialized streaming servers and has better scalability due to minimal state information on the server side.

One increasingly common mechanism for network delivery of media content is the client-controlled technology known as Dynamic Adaptive Streaming over HTTP (DASH). DASH exploits the stateless nature of the HTTP protocol by having a client send distinct requests each for a respective portion of audio-video (AV) data. A server responds to each such request by sending the corresponding data, which then terminates the transaction associated with that request. Each such HTTP request is handled as a completely standalone one-time transaction.

However, such methods have various short comings regarding changes to network bandwidth. When client devices are moving and/or they are using a 3G/LTE network, network bandwidth is often excessively unstable. Theoretically, when network bandwidth increases, a DASH client should request media segments with higher bitrate, and conversely request segments having a lower bitrate when network bandwidth decreases. However, aggressive changes to the types of streaming data being requested may result in visual artifacts in the video displayed based on the data. Alternatively, insufficiently aggressive changes to these types of streaming data may result in exhaustion of network bandwidth or exhaustion of AV data buffered at the client device. Consequently, there is a need to find mechanisms and techniques for efficiently changing the downloading of AV data in the context of adaptive streaming technologies such as DASH.

### BRIEF DESCRIPTION OF THE DRAWINGS

The various embodiments of the present invention are illustrated by way of example, and not by way of limitation, in the figures of the accompanying drawings and in which:

FIG. 1A is a block diagram illustrating elements of a system for exchanging a stream of data according to an embodiment.

FIG. 1B is a block diagram illustrating elements of audio-video data to be made available for access via a streaming network according to according to an embodiment.

FIG. 2 is a block diagram illustrating elements of a device to access audio-video data according to an embodiment.

FIG. 3 is a flow diagram illustrating elements of a method for accessing audio-video data according to an embodiment.

FIG. 4A is a flow diagram illustrating elements of a method for accessing audio-video data according to an embodiment.

FIG. 4B is a flow diagram illustrating elements of a method for accessing audio-video data according to an embodiment.

FIG. 5A is a timing diagram illustrating elements of an exchange of streaming data according to an embodiment.

FIGS. 5B through 5D are timing diagrams each illustrating a respective exchange of a data stream.

FIG. 6 is a block diagram illustrating elements of a computing system to download a data stream according to an embodiment.

FIG. 7 is a block diagram illustrating elements of a mobile device to download a data stream according to an embodiment.

### DETAILED DESCRIPTION

Embodiments discussed herein variously provide techniques and mechanisms to efficiently transition between downloading various (AV) data each to represent a respective portion of the same streaming content. A device may operate in a first mode to download and decode first data of an AV stream, the first data is encoded according to a first coding scheme. Based on a current state of a network, the device may transition to a second mode to download and decode second data of the AV stream which is encoded according to a second coding scheme. In one embodiment, only one of the first coding scheme and the second coding scheme supports a scalability feature—e.g. the scalability feature including an enhancement layer capability such as that of a scalable video coding (SVC) scheme. In addition, the device may evaluate the first downloaded data and the second downloaded data to determine whether other AV data is to be downloaded to mitigate a change in a quality of experience for a resulting AV display. Such other AV data may be used in addition to, or as an alternative to, the downloaded second data in the generating of the AV display.

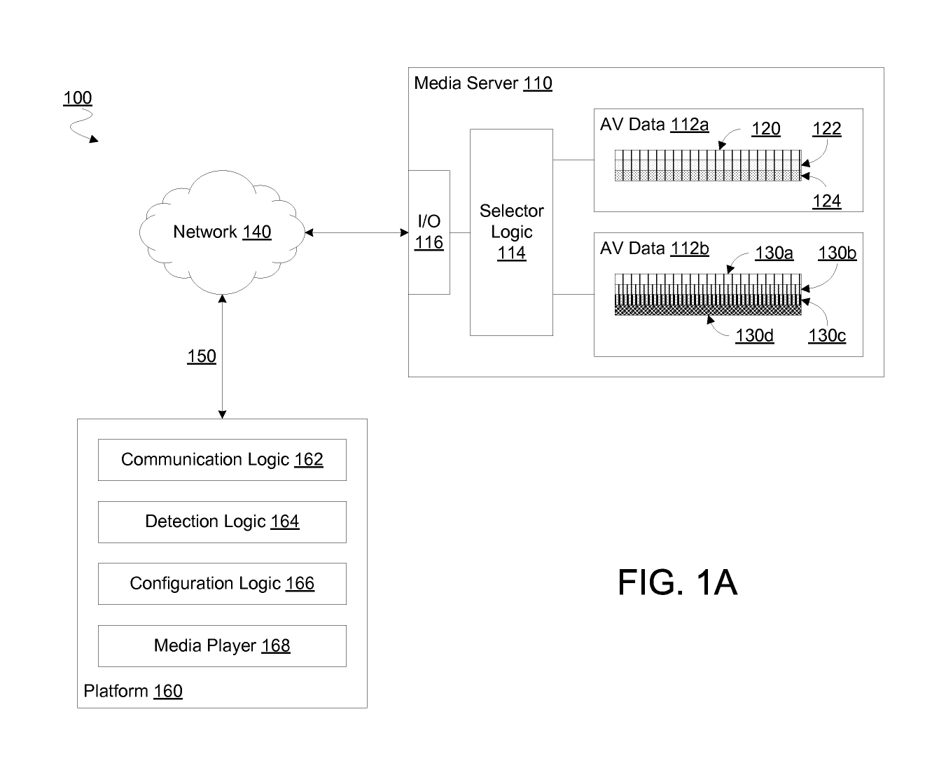

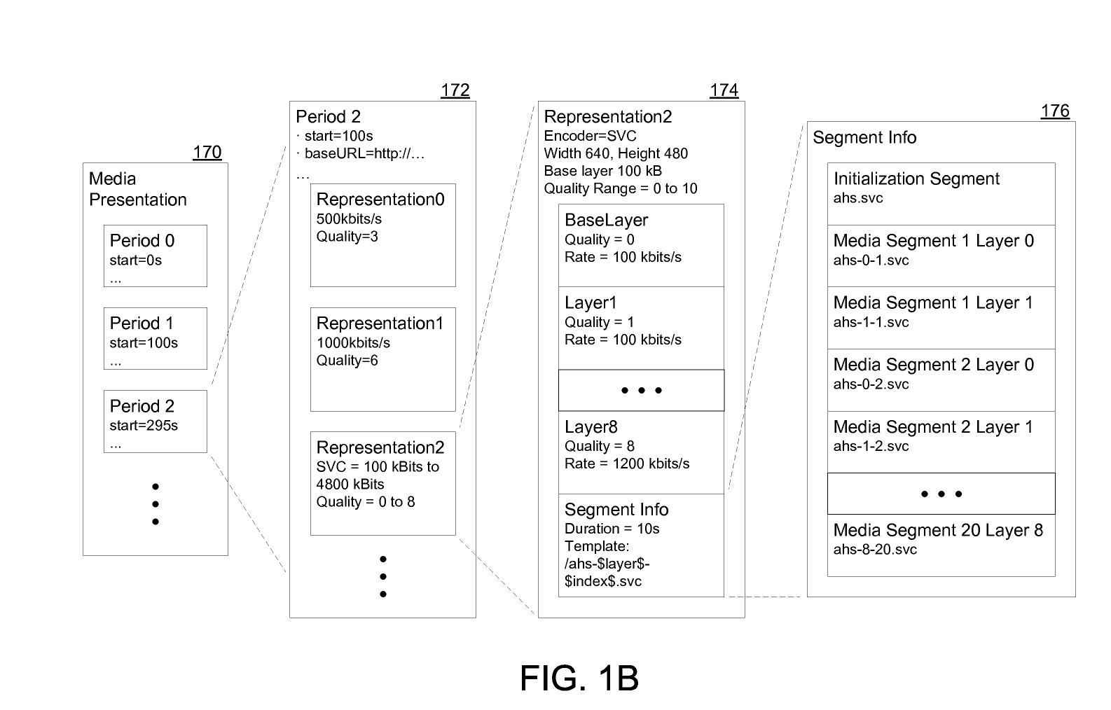

Referring now to FIG. 1A, a block diagram of procedures at a client and server for Dynamic Adaptive Streaming over HTTP (DASH) in accordance with one or more embodiments will be discussed. As shown in FIG. 1A, a DASH enabled system 100 includes a platform 160 able to obtain multimedia services from a server 110 via a network 140. Platform 160 may comprise hardware of a personal computer (e.g. desktop, laptop, notebook, etc.), mobile device (e.g. smartphone, palmtop, tablet), smart television, set-top box, gaming console or other such device suitable for participating in an exchange of a data stream. Typically, platform 160 comprises a general-purpose processor which is programmed in software to carry out various functions. The software may be downloaded to the processor in electronic form, over a network, for example, or it may, alternatively or additionally, be provided and/or stored on tangible media, such as magnetic, optical, or electronic memory. Network 140 may comprise a Wide Area Network (WAN), such as the Internet, a Metropolitan Area Network (MAN), a Local Area Network (LAN), a wired or wireless data network, or any other suitable network or combination of network types.

Media server 110 may provide platform 160 with access to any of various data which represent different respective versions the same audio-video content (such as different versions of the same television program, movie or the like). For example, media server 110 may variously include or otherwise have access to both AV data 112a representing a version of some content and AV data 112b representing another version of that same content. AV data 112a and AV data 112b may correspond to different respective schemes for coding (encoding and/or decoding) AV data—e.g. wherein portions of AV data 112b are encoded according to a coding scheme which supports some scalability feature, and portions of AV data 112a are encoded according to respective coding schemes which do not support that scalability feature. In an embodiment, the scalability feature includes an ability to supplement basic audio-video information with additional enhancement audio-video information for the generation of a particular frame of a displayed video sequence.

By way of illustration and not limitation, AV data 112b may include base layer (BL) frame information 130a and associated enhancement layer (EL) information, as represented by the illustrative EL frame information 130b, EL frame information 130c, EL frame information 130d. The respective EL frame information 130b, 130c, 130d may variously provide for enhancement of BL frame information 130a with respect to each of one or more video frames. For example, BL information 130a and EL information 130b, 130c, 130d may be different portions of AV content which are variously encoded according to the H.264/MPEG-4 standard released by the ITU Telecommunication Standardization Sector (ITU-T) Video Coding Experts Group (VCEG) and the ISO/IEC JTC1 Moving Picture Experts Group (MPEG) in May 2003.

Alternatively or in addition, AV data 112a may include multiple sets of frames—e.g. including some or all of the illustrative frames 120, frames 122, frames 124—which each represent a respective version of the same content represented by BL frame information 130a and EL frame information 130b, 130c, 130d. In an embodiment, sets of frames of AV data 112a provide for the generation display images independent of one another—e.g. where none of the sets of frames 120, 122, 124 provides for enhancement of any other of the sets of frames 120, 122, 124. Some or all of the sets of frames 120, 122, 124 may each provide a different respective level of quality (e.g. including different levels of resolution, peak signal-to-noise ratio and/or the like) with respect to the displaying of the same audio-video content.

Media server 110 may receive media content via audio/video input (not shown) which, for example, may be a live input stream or previously stored media content, wherein the representation of the content is to be streamed to platform 160. In such an embodiment, media server 110 may include logic (not shown) to generate some or all of AV data 112a, 122b based on the media content—e.g. including logic to encode the media content and/or to split the media content into a series of fragments or chunks suitable for streaming. In another embodiment, media server 110 receives such encoded and/or fragmented from another server or servers—e.g. where media server 110 is a web server, proxy server, gateway server or the like. Although shown as a single server, functionality of media server 110 may alternatively be implemented with a plurality of networked servers.

In an embodiment, platform 160 includes communication logic 162—e.g. including a web browser—to interact with network 140 for an exchange 150 of streaming data from media server 110 to platform 160. DASH provides an ability to locate at least some control of the “streaming session” to platform 160. By way of illustration and not limitation, communication logic 162 may open one or several or many 155 TCP connections to one or several standard HTTP servers or caches, retrieve a media presentation description (MPD) metadata file providing information on the structure and different versions of the media content stored in the media server 110, including for example different bitrates, frame rates, resolutions, codec types, and so on. The MPD information may be used to convey respective HTTP URLs of AV segments and associated metadata information to map segments into the media presentation timeline. Communication logic 162 may request new data in chunks using HTTP GET or partial HTTP GET messages to obtain smaller data segments (HTTP GET URL(FRAG1 REQ), FRAGMENT 1, HTTP GET URL(FRAGz REQ), FRAGMENT z) of the selected version of media file with individual HTTP GET messages which imitates streaming via short downloads. The URL of an HTTP GET message may be used to tell media server 110 which segment or segments the client is requesting. As a result, the communication logic 162 pulls the media from media server 110 segment by segment (or subsegment by subsegment based on byte range requests). Platform 160 may further comprise a media player 168 to decode and render such streaming data to generate a sequence of display images.

Implementation of DASH in system 100 provides platform 160 an ability to automatically choose an initial content rate to match initial available bandwidth without requiring the negotiation with network 140 and/or media server 110, and to dynamically switch between different bitrate representations of the media content as the available bandwidth changes. As a result, implementing DASH on system 100 allows faster adaptation to changing network and wireless link conditions, user preferences, content characteristics and device capabilities such as display resolution, processor speed and resources, memory resources, and so on. Such dynamic adaptation provides better user quality of experience (QoE) with shorter startup delays, fewer rebuffering events, better video quality, and so on. Example DASH technologies include Microsoft IIS Smooth Streaming™, Apple HTTP Live Streaming™, and Adobe HTTP Dynamic Streaming™. DASH technology may be implemented by various standards organizations including the Third Generation Partnership Project (3GPP), the Moving Picture Experts Group (MPEG) and the Open Internet Protocol Television (IPTV) Forum (OIPF), among others.

For example, during exchange 150, platform 160 may dynamically change a downloading of AV data to adapt for changes in available bitrate bandwidth and/or one or more other characteristics of network 140. By way of illustration and not limitation, communication logic 162 may send to input/output logic 116 of media server 110 one or more messages each to request a respective version of AV streaming content. Media server 110 may service such requests with selector logic 114 to select data to send for representing such streaming content. Such selection may include selector logic 114 selecting data from among portions of AV data 112a and/or portions of AV data 112b,

During exchange 150, detection logic 164 may receive an indication that network 140 is—or is expected to become—stable (or unstable) according to one or more criteria. In response to such an indication, detection logic 164 may signal configuration logic 166 to transition platform 160 among a plurality of operational modes which, for example, variously correspond to different respective coding schemes. Such transitioning may include configuration logic 166 reconfiguring communication logic 162 between a mode for downloading portions of AV data 112a and another mode for downloading portions of AV data 112b. Alternatively, such transitioning may include configuration logic 166 reconfiguring media player 168 between a mode for performing decoding portions of AV data 112a and another mode for decoding portions of AV data 112b. In an embodiment, a mode for accessing AV data 112a may include various submodes each for accessing a different respective one of frames 120, frames 122, frames 124.

In an embodiment, platform 160 includes hardware logic and/or software logic to prevent or otherwise mitigate one or more changes to a quality of experience which might otherwise take place in response to such a transition between modes of platform 160. Such logic may perform one or more evaluations based on first AV data downloaded prior to a mode transition and second AV data downloaded after that same mode transition. Based on such one or more evaluations, communication logic 162 detect whether third AV data is to be downloaded from media server 110. Where such third AV data is downloaded, the third AV data may be processed in addition to, or instead of, the second AV data to prevent or otherwise mitigate a change to a quality of experience metric associated with a displaying of the streamed content. FIG. 1B illustrates elements of audio-video data 170 to access for exchanging a stream of AV content according to an embodiment. Portions of AV data 170 may be variously exchanged in system 100 for example, such as in the exchange 150 between media server 110 and platform 160. AV data 170 may include some or all of the features of AV data 112a and/or some or all of the features of AV data 112b.

In an embodiment, a format of AV data 170 includes one or more features of the DASH MPD (Media Presentation Description) and/or includes one or more enhancements to the DASH MPD. By way of illustration and not limitation, AV data 170 may include media files which each correspond to a respective period of a sequence of periods for a content stream. Such files may each correspond, for example, to a respective period of time for communicating, processing, displaying or otherwise processing corresponding AV data. Metadata for each file may indicate a respective time—e.g. an offset relative to a reference time—which is associated with the file.

For a particular period of the sequence of periods, the corresponding file of AV data 170 may include or reference a plurality of representations each for the same portion of streaming content which is associated with that period. In the illustrative embodiment of FIG. 1B, AV data 170 includes respective files for a sequence of periods 0, 1, 2 . . . etc., some of all of which include respective representations each of the same image or sequence of images of a movie, television program or other such content.

For example, a file 172 for period 2 may include, or reference a location of, representations 0, 1 2, . . . etc. which are each associated with a respective coding scheme. One such representation—e.g. the illustrative representation 2 174—may include data encoded according to a coding scheme, such as SVC, which supports a scalability feature. In an embodiment, some or all of the other representations in file 172 are variously encoded according to respective coding schemes which do not support that scalability feature. By way of illustration and not limitation, representations 0 and 1 of file 172 may be representations for generating respective display images independent of one another, and independent of representation 2 174.

For brevity, a coding scheme which does not support a particular scalability feature of interest is referred to herein as a “non-SVC” scheme. Various versions of non-SVC encoded content may be generated, for example based on different H.264 AVC (Advanced Video Coding) encoding operations. However, the particular types of one or more non-SVC schemes used may not be limiting on certain embodiments. The various versions of non-SVC content may each correspond to a different respective QoE level—e.g. where each such quality level includes or is otherwise associated with a bit rate (e.g. 480 Kb/s for quality level 1, 720 Kb/s for quality level 2 and/or the like) for the respective encoded data. Typically, SVC encoded video has the same or similar QoE characteristics to those of certain types of non-SVC encoded video if the bit rate of the SVC video is on the order of 110% of that of the non-SVC video. Alternatively or in addition, PSNR (peak signal-to-noise ratio) may be a parameter for evaluation of a quality level metric for either or both of SVC video and non-SVC video.

In an embodiment, representation 2 174 includes segment information 176 for some number of downloadable media segments—e.g. twenty (20). Segment information 176 may include or reference a location of information for a base layer and some number of enhancement layers—e.g. eight (8)—which are available for variously providing a representation of each of the media segments. By way of illustration and not limitation, for each such media segment, segment information 176 may include, for each of the base layer and the enhancement layers, a respective reference to a file which includes audio-video data for that layer's representation of the media segment. Such files are illustrated in representation 176 by files ahs.svc, ahs-0-1.svc, ahs-1-1.svc, . . . etc.

In an embodiment, some or all of the representations for a period may each be associated with a respective level for a quality metric describing a quality of experience for displaying corresponding content. Such quality metric levels may be provided as a priori information which, for example, is based on the respective coding schemes for such representations. By way of illustration and not limitation, such a range of quality metric levels may include a range from zero (0) to eight (8), where representation 0 and 1 are associated with quality metric levels three (3) and six (6), respectively. Alternatively or in addition, representation 2 may include a base layer associated with a quality level of zero (0) and enhancement layers which are associated with different respective quality levels from one (1) to eight (8). Although certain embodiments are not limited in this regard, such QoE metric values may be distinct from—e.g. provided in addition to—information describing bitrates associated with the communicating of such representations. As discussed herein, such quality metric information for already-downloaded AV data may be generated and/or otherwise processed to determine whether additional and/or alternative AV data is to be downloaded for decoding to generate one more display images.

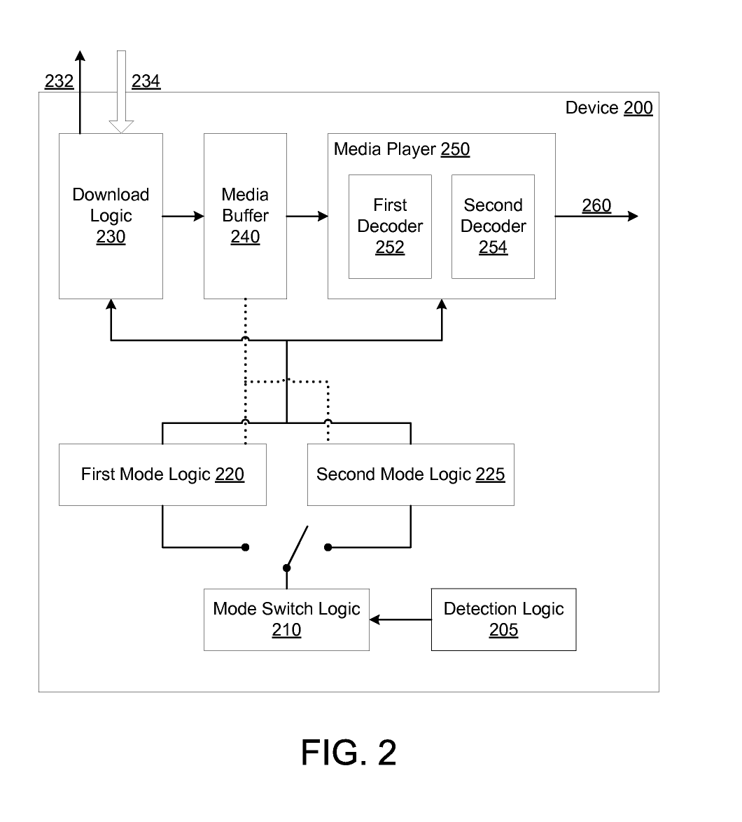

FIG. 2 illustrates elements of a device according to an embodiment for processing an audio-video steam. Device 200 may include some or all of the features of platform 160, for example. In an embodiment, device 200 participates in an exchange to selectively access portions of AV data such as AV data 170.

In an embodiment, device 200 includes communication logic—represented by the illustrative download logic 230—to receive a portion of an AV stream 234 during a first operational mode of the device 200, the first operational mode corresponding to a first AV coding scheme. Download logic 230—which, for example, may include some or all of a communication protocol stack such as one according to an Open Systems Interconnection (OSI) model—may send messages 232 to variously request streaming content via a network. In response to messages 232, respective portions of an AV stream 234 may be received over time, where download logic 320 variously buffers such portions—e.g. in a media buffer 240—prior to respective decoding of the portions. Such decoding may be performed by media player logic 250 which is included in or coupled to device 200.

Device 200 may further comprise detection logic 205 to detect for stability, or instability, of a network through which device 200 receives stream 234. For example, during receipt of AV stream 234, detection logic 205 may receive or otherwise detect control and/or other signaling from the network, where such signaling specifies or otherwise indicates a current or expected future state—e.g. including a bitrate capacity—of the network. Detection logic 205 may compare the indicated state of the network to a stability threshold during the first operational mode. Based on such comparing, detection logic 205 may signal configuration logic of device 200—e.g. including the illustrative mode switch logic 210—to transition device 200 between different operational modes.

For example, a first mode of device 200 may include operability of first mode logic 220 which, for example, is to signal download logic 230 to request that AV data of AV stream 234 be encoded according to the first coding scheme. Alternatively or in addition, first mode logic 220 may be configured to signal that media player logic 250 is to decode such AV data with a first decoder 252 associated with the first coding scheme—e.g. as opposed to using a second decoder 254 associated with a second coding scheme other than the first coding scheme. Based on such decoding by first decoder 252, media player logic 250 may generate a portion of an output 260 for displaying one or more images of the streamed content. By contrast, a second mode of device 200 may include operability of second mode logic 225 which, for example, is to signal download logic 230 to request that other AV data of AV stream 234 be encoded according to the second coding scheme. Alternatively or in addition, second mode logic 225 may signal that media player logic 250 is to decode such other AV data with second decoder 254 to generate a different portion of output 260.

In an embodiment, evaluation of network state by detection logic 205 may take place while platform 200 is in one of the first mode and the second mode. In response to detecting that the network is stable—or alternatively, in response to detecting that the network is unstable—detection logic 205 may signal mode switch logic 210 to transition from one of the first mode and the second mode to the other of the first mode and the second mode.

To illustrate certain features of various embodiments, a scenario is discussed herein with respect to a transition from the first mode of device 200 to the second mode 200. However, such discussion may be extended to additionally or alternatively apply to other mode transitions—e.g. from the second mode to the first mode. In an illustrative scenario, mode switch logic 210 may signal a transition to the second mode, resulting in media buffer 240 storing (at some point in time) the last one or more frames encoded according to the first coding scheme which were downloaded before the transition away from the first mode of device 200. Due to the mode transition, a next subsequent frame or frames to be downloaded—and in embodiment, stored in media buffer 240—are encoded according to the second coding scheme.

Certain embodiments regulate whether or how, in the decoding of frames by media player 250 to generate output 260, the last one or more frames according to the first coding scheme are to be immediately followed by the next subsequent frame or frames according to the second coding scheme. For example, device 200 may include logic to download additional and/or alternative AV data to prevent or otherwise mitigate a change to a quality of experience associated with a transition from the most recently downloaded frame or frames according to the first coding scheme to immediately to the next subsequent frame or frames according to the second coding scheme. The second mode logic 225 may evaluate one or more buffered frames to determine whether such a transition would correspond to an unacceptable change in quality of experience for viewers of the resulting display.

For example, second mode logic 225 may evaluate a difference between respective quality metric levels for each of a buffered frame encoded according to the first coding scheme and a next downloaded frame encoded according to the second coding scheme. Where that evaluated difference violates some test criteria—e.g. some threshold difference level—second mode logic 225 may signal download logic 230 to download additional or alternative AV data for use in providing a smaller change in QoE.

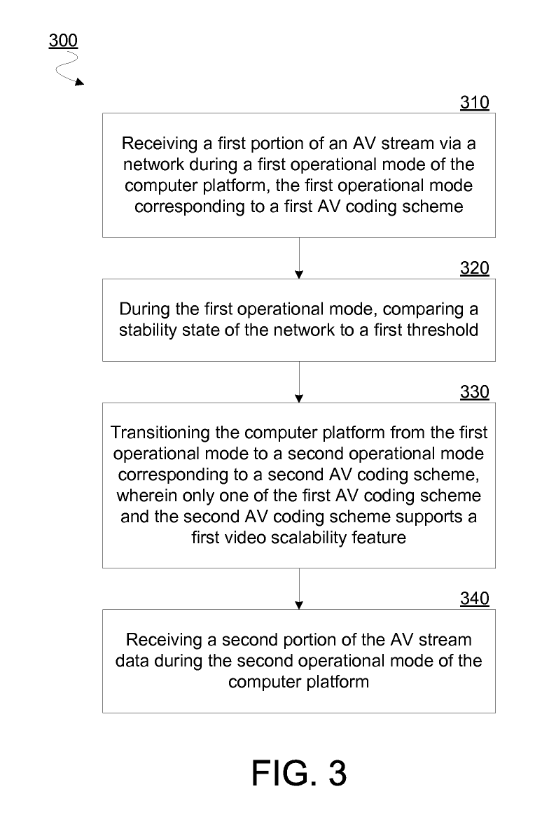

FIG. 3 illustrates elements of a method 300 for exchanging streaming AV data according to an embodiment. Method 300 may be performed by device 200, for example. In an embodiment, method 300 is performed to variously exchange portions of data including some or all of the features of AV data 112a and AV data 112b.

Method 300 may include receiving, at 310, a first portion of an AV stream via a network during a first operational mode of the computer platform. In an embodiment, a plurality of operational modes of the computer platform includes the first operational mode corresponding to a first AV coding scheme, and a second operational mode corresponding to a second coding scheme other than the first coding scheme. For example, the first coding scheme may be for the computer platform to download and/or decode data which is encoded according to the first coding scheme, whereas the second coding scheme may be for the computer platform to download and/or decode data encoded according to the second coding scheme.

During the first operational mode, method 300 may perform comparing, at 320, a stability state of the network to a first threshold. In various embodiments, the stability state may include one or more of a bitrate capacity of the network and a rate of change of such a bitrate capacity (e.g. including a first-order rate of change, a second-order rate of change and/or the like). Based on the comparing the stability state to the first threshold at 320, method 300 may include transitioning the computer platform, at 330, from the first operational mode to the second operational mode. In an embodiment, only one of the first AV coding scheme and the second AV coding scheme supports a first video scalability feature such as the ability to supplement base layer information with enhancement layer information for the generation of a display image. In an embodiment, method 300 further comprises, at 340, receiving a second portion of the AV stream data during the second operational mode of the computer platform.

In an illustrative embodiment, the comparing at 320 may comprise comparing a current download speed to a threshold download speed, comparing the current download speed a download speed of some earlier time—e.g. 5 seconds earlier—and/or any of a variety of other comparisons to detect for network stability or instability. For example, the first threshold may include a maximum rate of decrease of the bitrate of the network, or a minimum level of such a bitrate. If such comparing indicates an unacceptably small bitrate, an unacceptably large decrease in bitrate and/or various other indicia of network instability, then the transitioning at 330 may include configuring the computer platform for a SVC mode of operation.

Alternatively, where the comparing at 320 instead indicates network stability—e.g. where a change in network bitrate over some period of time is less than a threshold (such as 10%, for example)—then the transitioning at 330 may include configuring the computer platform for a mode to process data which is encoded according to one or more coding schemes other than an SVC scheme. For example, the first threshold may include a minimum period of time during which any change to a bitrate of the network is an increase. Accordingly, the network may be found to be stable at 320 where no decrease in network bitrate is detected for such a minimum period of time.

Method 300 may include one or more other operations (not shown) performed while the computer platform is in the second operational mode to which it transitions at 330. For example, during the second operational mode, method 400 may further comprise detecting whether a difference between a first quality of the first portion and a second quality of the second portion exceeds a second threshold. Based on such detecting, method 400 may include determining whether to further download first AV data—e.g. to mitigate a change in a quality of experience in a displayed image which would otherwise result from the transitioning at 330. For example, the first AV data may represent an image frame which is also represented by one of the first portion and the second portion, where the first AV data may be used to represent the image frame in lieu of, or in addition to, using the second portion for representing that image frame.

For example, where the second mode is associated with SVC coding, SVC mode logic of the computer platform may evaluate the respective quality levels of one or more nonSVC segments currently buffered by the computer platform to determine whether any additional SVC data is to be downloaded—e.g. in addition to the next one or more SVC segments already downloaded subsequent to the transition at 330. By way of illustration and not limitation, additional enhancement layer information for the already-downloaded one or more SVC segments may be requested where a difference between respective QoE metric levels for the SVC and non-SVC segments exceeds a threshold. The threshold level may be zero (0), for example, although certain embodiments are not limited in this regard.

For example, a downloaded SVC segment B of quality level QB may be immediately subsequent to a buffered nonSVC segment A of quality level QA in a sequence of segments for representing streaming content. Where a non-zero difference D between QB and QA is indicated—e.g. where D=(QB−QA)—an enhancement layer associated with a quality level of (or closest to) QB′=(QB−D/2) may be subsequently requested from the media server in response to detecting the difference D. The enhancement layer may then be used to supplement an already downloaded SVC segment to provide a smoother transition to a QoE for the resulting displayed image. One or more similar quality levels—e.g. including QB″=(QB−D/4), QB″=(QB−D/16) and/or the like—may be determined and subsequently applied to determine whether or how any later-in-time SVC segments are to be selectively enhanced to smooth a QoE change associated with the transitioning at 330.

Alternatively or in addition, the transitioning at 330 may include transitioning from a mode associated with SVC coding to a mode associated with one or more nonSVC coding schemes. In such an embodiment, nonSVC mode logic of the computer platform may take into account the respective quality levels of one or more SVC segments currently buffered by the computer platform. One or more nonSVC segments downloaded subsequent to the transition at 330 may be selectively replaced with alternative segments according to a different nonSVC coding scheme. Where a difference between respective QoE metric levels for the downloaded non-SVC and SVC segments exceeds a threshold, method 400 may include the computer platform requesting and downloading alternative nonSVC segments which, for example, are encoded according to another nonSVC coding scheme other than that associated with the already downloaded one or more nonSVC segments. The alternative nonSVC segments may be decoded and used, in lieu of some or all nonSVC segments received at 340, for generating an image display.

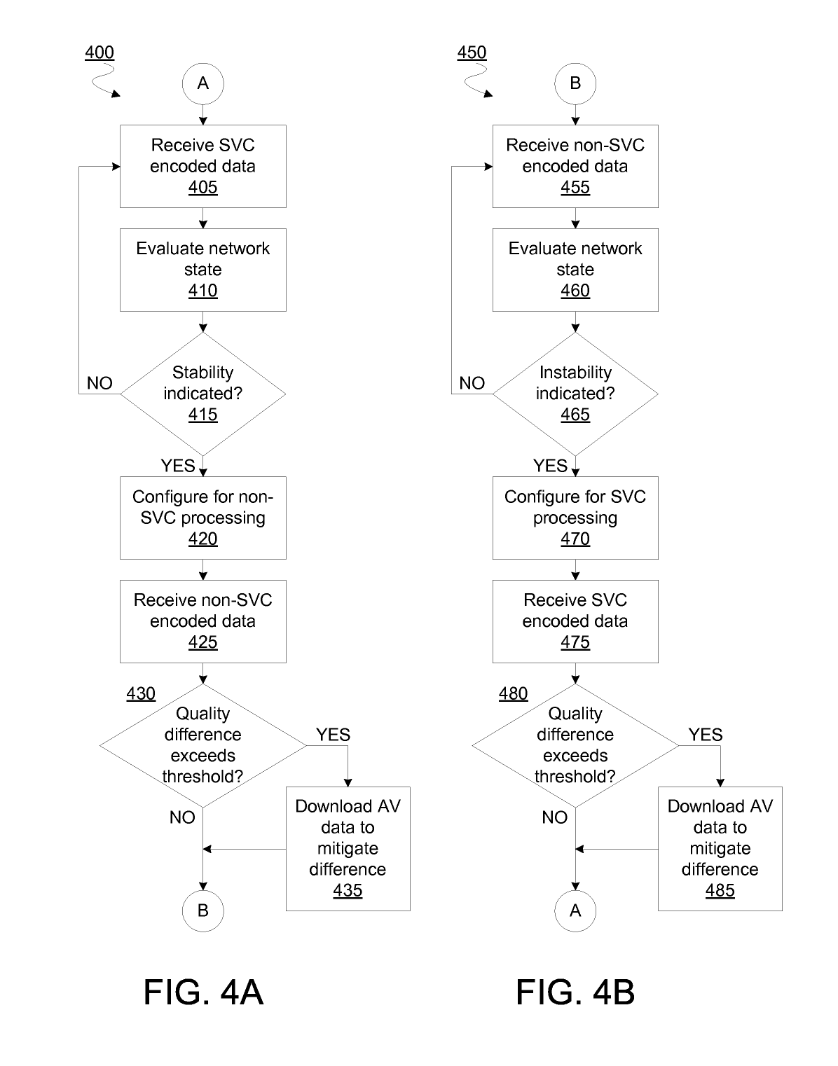

FIG. 4A illustrates elements of a method 400 for exchanging an AV stream according to an embodiment. Method 400 may be performed with hardware providing the functionality of platform 160 and/or the functionality of device 200, for example. In an embodiment, method 400 includes some or all of the features of method 300.

Method 400 may include receiving, at 405, SVC encoded data of a data stream. For example, the receiving at 405 may be performed during a mode of operation of a platform which is for downloading and processing SVC data to generate a portion of a streaming image display. During such a mode, method 400 may further perform, at 410, an evaluating a state of a network from which the SVC encoded data is received at 405. The evaluating at 410 may include, for example, comparing a bitrate capacity or other network characteristic to a threshold level.

Based on the evaluating at 410, method 400 may determine at 415 whether a stability of the network is indicated. For example, stability of the network may be indicated where no decrease in a network bitrate is detected for at least some threshold minimum period of time—e.g. five (5) seconds. Where stability of the network is not indicated at 415, method 400 may return to receiving additional SVC encoded data at 405. However, where stability of the network is indicated at 415, method 400 may include, at 420, configuring the hardware to process data of the AV stream which is encoded to a coding scheme other than SVC. The configuring at 420 may include, for example, some of all of the features of the transitioning at 330.

In an embodiment, method 400 further comprises receiving, at 425, non-SVC encoded data of the AV stream. NonSVC encoded data downloaded at 425 may be compared to SVC encoded data most recently downloaded at 405. For example, respective quality metric levels for a nonSVC-encoded frame and a SVC-encoded frame may be evaluated to determine, at 430, whether a difference between such quality metric levels exceeds a threshold change in QoE for a displaying of streaming images.

Where the difference between such quality metric levels is determined at 430 to not exceed the threshold, method 400 may end or, alternatively, proceed to additional operations of a method 450 discussed herein. By contrast, where the difference between such quality metric levels is determined at 430 to exceed the threshold, method 400 may, at 435, download other AV data to mitigate the difference. For example, the downloading at 435 may include downloading another one or more frames encoded according to a different non-SCV coding scheme. Such one or more other frames downloaded at 435 may be decoded—e.g. in lieu of one or more non-SVC encoded frames which are downloaded at 425—for operations (not shown) to generate a portion of a displayed streaming image. In an embodiment, method 400 may end after such operations or, alternatively, proceed to additional operations of method 450.

FIG. 4B illustrates elements of method 450 for exchanging an AV stream according to an embodiment. Method 450 may be performed with hardware providing the functionality of platform 160 and/or the functionality of device 200, for example. In an embodiment, method 450 includes some or all of the features of method 300.

Method 450 may include receiving, at 455, non-SVC encoded data of a data stream. For example, the receiving at 455 may be performed during a mode of operation of a platform which is for downloading and processing non-SVC data to generate a portion of a displayed streaming image. During such a mode, method 450 may further perform, at 460, an evaluating a state of a network from which the non-SVC encoded data is received at 455. The evaluating at 460 may include, for example, some or all of the features of the evaluating at 410 and/or the comparing at 320.

Based on the evaluating at 460, method 450 may determine at 465 whether an instability of the network is indicated. For example, instability of the network may be indicated where the bitrate of the network is at or below some threshold level, where a rate of decrease of the bitrate (or a rate of acceleration of such decrease) exceeds a maximum threshold level, or the like. Where instability of the network is not indicated at 465, method 450 may return to receiving additional non-SVC encoded data at 455. However, where stability of the network is indicated at 465, method 450 may include, at 470, configuring the hardware to process data of the AV stream which is encoded to an SVC coding scheme. The configuring at 470 may include, for example, some of all of the features of the transitioning at 330.

In an embodiment, method 450 further comprises receiving, at 475, SVC encoded data of the AV stream. SVC encoded data may be downloaded at 475 and compared to non-SVC encoded data most recently downloaded at 455. For example, respective quality metric levels for a SVC-encoded frame and a nonSVC-encoded frame may be evaluated to determine, at 480, whether a difference between such quality metric levels exceeds a threshold change in QoE for a streaming image display.

Where the difference between such quality metric levels is determined at 480 to not exceed the threshold method 450 may end or, alternatively, proceed to additional operations of method 400. By contrast, where the difference between such quality metric levels is determined at 480 to exceed the threshold, method 450 may, at 485, download additional AV data to mitigate the difference. For example, the downloading at 485 may include downloading one or more additional enhancement layers for some or all of the SVC encoded data already downloaded at 475. Such one or more additional enhancement layers downloaded at 485 may be decoded—e.g. in combination with the SVC encoded frames downloaded at 475—for operations (not shown) to generate a portion of the streaming image display. In an embodiment, method 450 may end after such operations or, alternatively, proceed to additional operations of method 450.

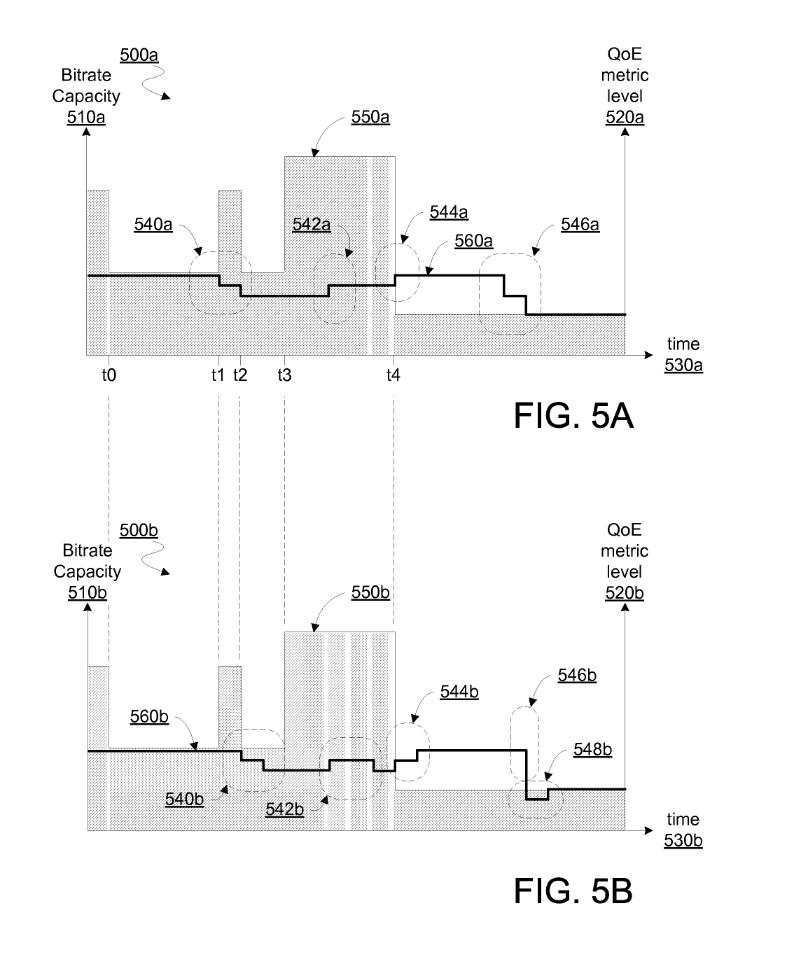

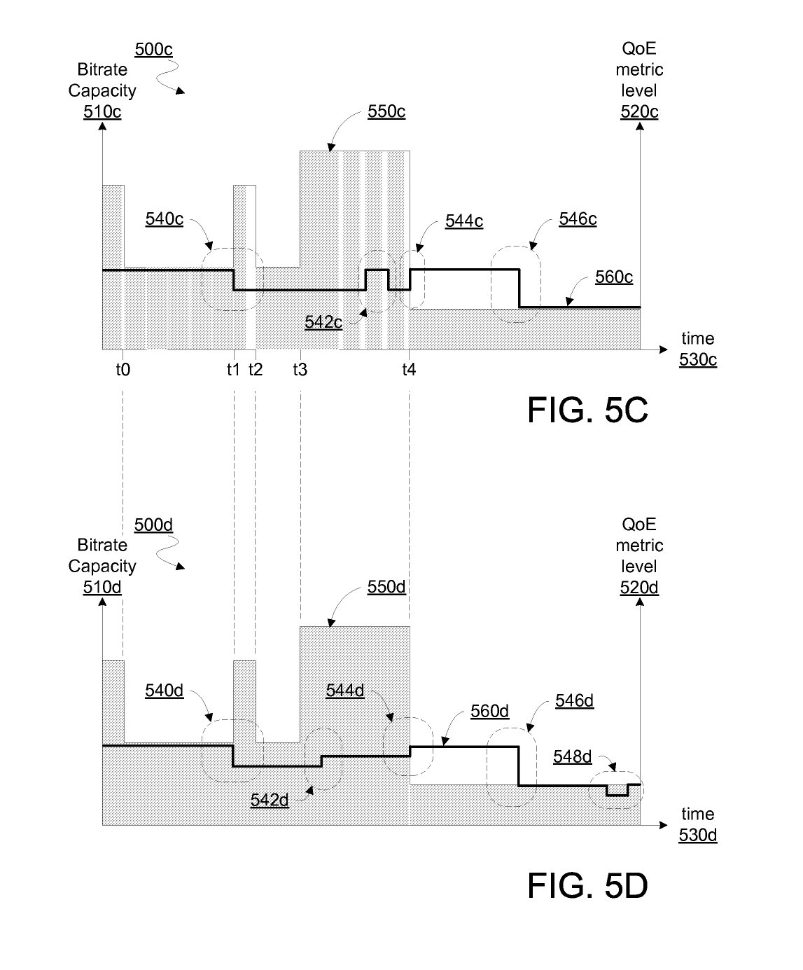

FIGS. 5A through 5D represent, respectively, graphs 500a, 500b, 500c, 500d which each show features of AV streaming according to hardware which may operate in a device according to an embodiment. Graphs 500a, 500b, 500c, 500d comprise respective axes 530a, 530b, 530c, 530d each for a period of time during which a corresponding AV data stream is downloaded. Graphs 500a, 500b, 500c, 500d further comprise axes 510a, 510b, 510c, 510d for respective plots 550a, 550b, 550c, 550d of network bitrate capacity during such a period of time. To illustrate features of certain embodiments, plots 550a, 550b, 550c, 550d show the same transitions at the same respective times t0, t1, t2, t3, t4 along axes 510a, 510b, 510c, 510d. However, the various transitions of plots 550a, 550b, 550c, 550d—and the timing thereof—are merely illustrative, and not limiting on certain embodiments.

Graphs 500a, 500b, 500c, 500d further comprise axes 520a, 520b, 520c, 520d for respective plots 560a, 560b, 560c, 560d each of QoE metric levels for downloaded portions of a corresponding AV data stream. Plot 560a illustrates changes to QoE for streaming data which is downloaded according to techniques such as those of method 400 and/or method 450. Plot 560b illustrates changes to QoE for streaming data which is downloaded according to a non-SVC mode including different non-SVC submodes, where AV data encoded according to different non-SVC coding schemes (and not any SVC coding scheme) are selectively downloaded at different times based on changes to the bitrate represented by plot 550b. The different non-SVC schemes may each be associated with a respective QoE metric level. Plot 560c also illustrates changes to QoE for streaming data which is downloaded according to a non-SVC mode including multiple non-SVC sub-modes, where the transitioning between non-SVC schemes is relatively aggressive (fast), as compared to the transitioning represented by plot 560b. Plot 560d illustrates changes to QoE for streaming data which is downloaded according to an SVC mode only—i.e. without transitioning from such SCV mode logic to any alternative non-SVC mode or modes.

Plot 560a includes transitions 540a which are in response to the decline in plot 550a at time t0. Plots 550b, 550c, 550d include respective transitions 540b, 540c, 540d which variously correspond to transitions 540a. However, as compared to transitions 540a, each of transitions 540b, 540c, 540d is either relatively late, or relatively sharp. Late transitions are more likely to result in an exhaustion of network bandwidth, and sharp transitions are more likely to result in noticeable visual artifacts in a display of streaming images.

Plot 560a also includes a transition 542a which is in response to the pulse in plot 550a between times t1 and t2. Plots 550b, 550c, 550d include respective transitions 542b, 542c, 542d which correspond to transition 542a. As compared to transition 542a, transitions 542b and 542c are relatively jittery, since plot 560a does not include any drop after transition 542a corresponding to the drop in plot 550a at time t2. Rather, QoE smoothing techniques such as those discussed herein provide for comparatively slow incremental changes to the QoE metric level, despite fluctuations of plot 550a between times t1 and t3.

Plot 560a also includes a transition 544a which is in response to the increase in plot 550a at time t3. Plots 550b, 550c, 550d include respective transitions 544b, 544c, 544d which correspond to transitions 544a. As compared to transition 544a, transitions 544b are relatively late to complete, and transition 544c is relatively sharp. Late increases in QoE for a data stream are relatively likely to result in exhaustion of buffered video frames, while the sharp increase of transition 544c is more likely to result in a display having more noticeable visual artifacts.

Plot 560a also includes transitions 546a which are in response to the decrease in plot 550a at time t4. Plots 550b, 550c, 550d include respective transitions 546b, 546c, 546d which correspond to transitions 546a. As compared to transition 546a, transitions 546b, 546c, 546d are each later, more sharp, or both. These large drops in QoE metric levels for plots 550b, 550c, 550d may be very noticeable to a viewer of the resulting streamed images to be displayed. Moreover, plots 560b and 560d further comprise respective dips 548b, 548d in response to the relatively large bitrate decrease at time t4.

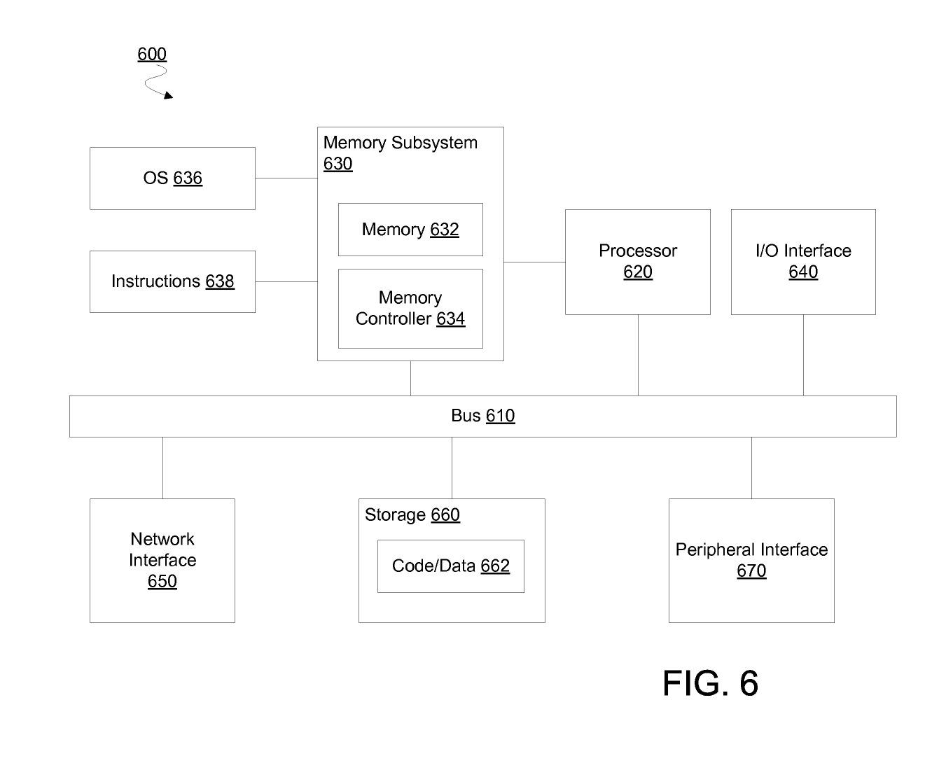

FIG. 6 is a block diagram of an embodiment of a computing system with which data streaming may be implemented. System 600 represents a computing device in accordance with any embodiment described herein, and may be a laptop computer, a desktop computer, a gaming or entertainment control system, or other electronic device. System 600 may include processor 620, which provides processing, operation management, and execution of instructions for system 600. Processor 620 may include any type of microprocessor, central processing unit (CPU), processing core, or other processing hardware to provide processing for system 600. Processor 620 controls the overall operation of system 600, and may be or include, one or more programmable general-purpose or special-purpose microprocessors, digital signal processors (DSPs), programmable controllers, application specific integrated circuits (ASICs), programmable logic devices (PLDs), or the like, or a combination of such devices.

Memory subsystem 630 represents the main memory of system 600, and provides temporary storage for code to be executed by processor 620, or data values to be used in executing a routine. Memory subsystem 630 may include one or more memory devices such as read-only memory (ROM), flash memory, one or more varieties of random access memory (RAM), or other memory devices, or a combination of such devices. Memory subsystem 630 stores and hosts, among other things, operating system (OS) 636 to provide a software platform for execution of instructions in system 600. Additionally, other instructions 638 are stored and executed from memory subsystem 630 to provide the logic and the processing of system 600. OS 636 and instructions 638 are executed by processor 620. Memory subsystem 630 may include memory device 632 where it stores data, instructions, programs, or other items. In one embodiment, memory subsystem includes memory controller 634 to provide access to memory device 632.

Processor 620 and memory subsystem 630 are coupled to bus/bus system 610. Bus 610 is an abstraction that represents any one or more separate physical buses, communication lines/interfaces, and/or point-to-point connections, connected by appropriate bridges, adapters, and/or controllers. Therefore, bus 610 may include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (commonly referred to as “Firewire”). The buses of bus 610 may also correspond to interfaces in network interface 650.

System 600 may also include one or more input/output (I/O) interface(s) 640, network interface 650, one or more internal mass storage device(s) 660, and peripheral interface 670 coupled to bus 610. I/O interface 640 may include one or more interface components through which a user interacts with system 600 (e.g., video, audio, and/or alphanumeric interfacing). Network interface 650 provides system 600 the ability to communicate with remote devices (e.g., servers, other computing devices) over one or more networks. Network interface 650 may include an Ethernet adapter, wireless interconnection components, USB (universal serial bus), or other wired or wireless standards-based or proprietary interfaces.

Storage 660 may be or include any conventional medium for storing large amounts of data in a nonvolatile manner, such as one or more magnetic, solid state, or optical based disks, or a combination. Storage 660 holds code or instructions and data 662 in a persistent state (i.e., the value is retained despite interruption of power to system 600). Storage 660 may be generically considered to be a “memory,” although memory 630 is the executing or operating memory to provide instructions to processor 620. Whereas storage 660 is nonvolatile, memory 630 may include volatile memory (i.e., the value or state of the data is indeterminate if power is interrupted to system 600).

Peripheral interface 670 may include any hardware interface not specifically mentioned above. Peripherals refer generally to devices that connect dependently to system 600. A dependent connection is one where system 600 provides the software and/or hardware platform on which operation executes, and with which a user interacts.

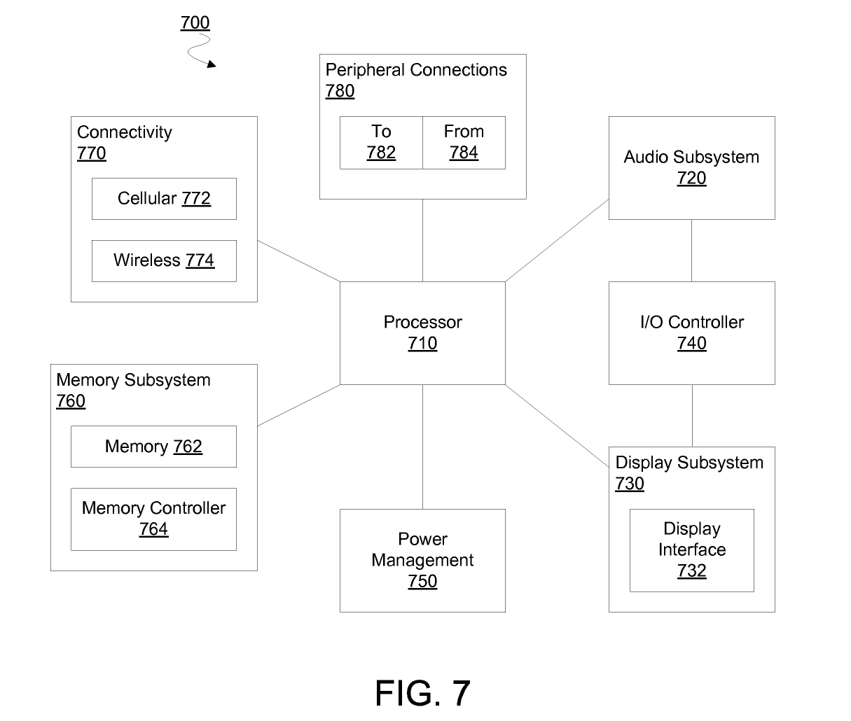

FIG. 7 is a block diagram of an embodiment of a mobile device with which data streaming may be implemented. Device 700 represents a mobile computing device, such as a computing tablet, a mobile phone or smartphone, a wireless-enabled e-reader, or other mobile device. It will be understood that certain of the components are shown generally, and not all components of such a device are shown in device 700.

Device 700 may include processor 710, which performs the primary processing operations of device 700. Processor 710 may include one or more physical devices, such as microprocessors, application processors, microcontrollers, programmable logic devices, or other processing means. The processing operations performed by processor 710 include the execution of an operating platform or operating system on which applications and/or device functions are executed. The processing operations include operations related to I/O (input/output) with a human user or with other devices, operations related to power management, and/or operations related to connecting device 700 to another device. The processing operations may also include operations related to audio I/O and/or display I/O.

In one embodiment, device 700 includes audio subsystem 720, which represents hardware (e.g., audio hardware and audio circuits) and software (e.g., drivers, codecs) components associated with providing audio functions to the computing device. Audio functions may include speaker and/or headphone output, as well as microphone input. Devices for such functions may be integrated into device 700, or connected to device 700. In one embodiment, a user interacts with device 700 by providing audio commands that are received and processed by processor 710.

Display subsystem 730 represents hardware (e.g., display devices) and software (e.g., drivers) components that provide a visual and/or tactile display for a user to interact with the computing device. Display subsystem 730 may include display interface 732, which may include the particular screen or hardware device used to provide a display to a user. In one embodiment, display interface 732 includes logic separate from processor 710 to perform at least some processing related to the display. In one embodiment, display subsystem 730 includes a touchscreen device that provides both output and input to a user.

I/O controller 740 represents hardware devices and software components related to interaction with a user. I/O controller 740 may operate to manage hardware that is part of audio subsystem 720 and/or display subsystem 730. Additionally, I/O controller 740 illustrates a connection point for additional devices that connect to device 700 through which a user might interact with the system. For example, devices that may be attached to device 700 might include microphone devices, speaker or stereo systems, video systems or other display device, keyboard or keypad devices, or other I/O devices for use with specific applications such as card readers or other devices.

As mentioned above, I/O controller 740 may interact with audio subsystem 720 and/or display subsystem 730. For example, input through a microphone or other audio device may provide input or commands for one or more applications or functions of device 700. Additionally, audio output may be provided instead of or in addition to display output. In another example, if display subsystem includes a touchscreen, the display device also acts as an input device, which may be at least partially managed by I/O controller 740. There may also be additional buttons or switches on device 700 to provide I/O functions managed by I/O controller 740.

In one embodiment, I/O controller 740 manages devices such as accelerometers, cameras, light sensors or other environmental sensors, gyroscopes, global positioning system (GPS), or other hardware that may be included in device 700. The input may be part of direct user interaction, as well as providing environmental input to the system to influence its operations (such as filtering for noise, adjusting displays for brightness detection, applying a flash for a camera, or other features).

In one embodiment, device 700 includes power management 750 that manages battery power usage, charging of the battery, and features related to power saving operation. Memory subsystem 760 may include memory device(s) 762 for storing information in device 700. Memory subsystem 760 may include nonvolatile (state does not change if power to the memory device is interrupted) and/or volatile (state is indeterminate if power to the memory device is interrupted) memory devices. Memory 760 may store application data, user data, music, photos, documents, or other data, as well as system data (whether long-term or temporary) related to the execution of the applications and functions of system 700. In one embodiment, memory subsystem 760 includes memory controller 764 (which could also be considered part of the control of system 700, and could potentially be considered part of processor 710). Memory controller 764 to access memory 762.

Connectivity 770 may include hardware devices (e.g., wireless and/or wired connectors and communication hardware) and software components (e.g., drivers, protocol stacks) to enable device 700 to communicate with external devices. The device could be separate devices, such as other computing devices, wireless access points or base stations, as well as peripherals such as headsets, printers, or other devices.

Connectivity 770 may include multiple different types of connectivity. To generalize, device 700 is illustrated with cellular connectivity 772 and wireless connectivity 774. Cellular connectivity 772 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 774 refers to wireless connectivity that is not cellular, and may include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 780 include hardware interfaces and connectors, as well as software components (e.g., drivers, protocol stacks) to make peripheral connections. It will be understood that device 700 could both be a peripheral device (“to” 782) to other computing devices, as well as have peripheral devices (“from” 784) connected to it. Device 700 commonly has a “docking” connector to connect to other computing devices for purposes such as managing (e.g., downloading and/or uploading, changing, synchronizing) content on device 700. Additionally, a docking connector may allow device 700 to connect to certain peripherals that allow device 700 to control content output, for example, to audiovisual or other systems.

In addition to a proprietary docking connector or other proprietary connection hardware, device 700 may make peripheral connections 780 via common or standards-based connectors. Common types may include a Universal Serial Bus (USB) connector (which may include any of a number of different hardware interfaces), DisplayPort including MiniDisplayPort (MDP), High Definition Multimedia Interface (HDMI), Firewire, or other type. It will be appreciated that some or all components in either or each of the systems depicted in FIGS. 6 and 7 may be combined in a system-on-a-chip (SoC) architecture, in various embodiments.

In one implementation, a device comprises communication logic to receive a first portion of an audio-video (AV) stream via a network during a first operational mode of the computer platform, the first operational mode corresponding to a first AV coding scheme. The device further comprises detection logic to perform a comparison of a stability state of the network to a first threshold during the first operational mode, and configuration logic to transition the computer platform, based on the comparison, from the first operational mode to a second operational mode corresponding to a second AV coding scheme, wherein only one of the first AV coding scheme and the second AV coding scheme supports a video scalability feature, wherein the communication logic is to receive a second portion of the AV stream data based on the second operational mode of the computer platform.

In an embodiment, the device further comprises second mode logic to determine, based on a difference between a first quality of the first portion and a second quality of the second portion, whether to download first AV data. In another embodiment, the second mode logic is to detect during the second operational mode whether a difference between the first quality and the second quality exceeds a second threshold, and based to download the first AV data in response to the difference exceeds the second threshold. In another embodiment, the second encoding scheme supports the video scalability feature, wherein the second mode logic determines to download the first AV data to enhance the second portion.

In another embodiment, the first encoding scheme supports the video scalability feature, wherein the second mode logic determines to download the first AV data as an alternative to the second portion. In another embodiment, the first AV data represents an AV frame which is also represented by one of the first portion and the second portion. In another embodiment, the first encoding scheme supports the video scalability feature, wherein the comparison indicates a stability of the network. In another embodiment, the first threshold includes a minimum period of time during which any change to a bandwidth of the network is an increase. In another embodiment, the second encoding scheme supports the video scalability feature, wherein the comparison indicates an instability of the network. In another embodiment, the first threshold includes a maximum rate of decrease of a bandwidth of the network. In another embodiment, the first threshold includes a minimum level of a bandwidth of the network. In another embodiment, the one of the first AV coding scheme and the second AV coding scheme is a scalable video coding scheme.

In another implementation, a method at a computer platform comprises receiving a first portion of an audio-video (AV) stream via a network during a first operational mode of the computer platform, the first operational mode corresponding to a first AV coding scheme, and during the first operational mode, comparing a stability state of the network to a first threshold. The method further comprises, based on the comparing the stability state to the first threshold, transitioning the computer platform from the first operational mode to a second operational mode corresponding to a second AV coding scheme, wherein only one of the first AV coding scheme and the second AV coding scheme supports a video scalability feature. The method further comprises receiving a second portion of the AV stream data during the second operational mode of the computer platform.

In an embodiment, the method further comprises, during the second operational mode, detecting whether a difference between a first quality of the first portion and a second quality of the second portion exceeds a second threshold, and based on the detecting whether the difference exceeds the second threshold, determining whether to download first AV data. In another embodiment, the second encoding scheme supports the video scalability feature, the method further comprising downloading the first AV data to enhance the second portion. In another embodiment, the first encoding scheme supports the video scalability feature, the method further comprising downloading the first AV data as an alternative to the second portion. In another embodiment, the first AV data represents an AV frame which is also represented by one of the first portion and the second portion. In another embodiment, the first encoding scheme supports the video scalability feature, wherein the comparing the stability state to the first threshold indicates a stability of the network. In another embodiment, the first threshold includes a minimum period of time during which any change to a bandwidth of the network is an increase. In another embodiment, the second encoding scheme supports the video scalability feature, wherein the comparing the stability state to the first threshold indicates an instability of the network. In another embodiment, wherein the first threshold includes a maximum rate of decrease of a bandwidth of the network. In another embodiment, wherein the first threshold includes a minimum level of a bandwidth of the network. In another embodiment, wherein the one of the first AV coding scheme and the second AV coding scheme is a scalable video coding scheme.

In another implementation, a computer-readable storage medium has stored thereon instructions which, when executed by one or more processing units, cause the one or more processing units to perform a method comprising receiving a first portion of an audio-video (AV) stream via a network during a first operational mode of the computer platform, the first operational mode corresponding to a first AV coding scheme. The method further comprises, during the first operational mode, comparing a stability state of the network to a first threshold, and based on the comparing the stability state to the first threshold, transitioning the computer platform from the first operational mode to a second operational mode corresponding to a second AV coding scheme, wherein only one of the first AV coding scheme and the second AV coding scheme supports a video scalability feature. The method further comprises receiving a second portion of the AV stream data during the second operational mode of the computer platform.

In an embodiment, the method further comprises, during the second operational mode, detecting whether a difference between a first quality of the first portion and a second quality of the second portion exceeds a second threshold, and based on the detecting whether the difference exceeds the second threshold, determining whether to download first AV data. In another embodiment, the second encoding scheme supports the video scalability feature, the method further comprising downloading the first AV data to enhance the second portion. In another embodiment, the first encoding scheme supports the video scalability feature, the method further comprising downloading the first AV data as an alternative to the second portion. In another embodiment, the first AV data represents an AV frame which is also represented by one of the first portion and the second portion. In another embodiment, the first encoding scheme supports the video scalability feature, wherein the comparing the stability state to the first threshold indicates a stability of the network. In another embodiment, the first threshold includes a minimum period of time during which any change to a bandwidth of the network is an increase. In another embodiment, the second encoding scheme supports the video scalability feature, wherein the comparing the stability state to the first threshold indicates an instability of the network. In another embodiment, the first threshold includes a maximum rate of decrease of a bandwidth of the network. In another embodiment, the first threshold includes a minimum level of a bandwidth of the network. In another embodiment, the one of the first AV coding scheme and the second AV coding scheme is a scalable video coding scheme.

In another implementation, a system comprises a server to transmit an audio-video stream (AV) via a network, and a client device coupled to the server via the network. The client device includes communication logic to receive a first portion of the AV stream during a first operational mode of the client device, the first operational mode corresponding to a first AV coding scheme, and detection logic to perform a comparison of a stability state of the network to a first threshold during the first operational mode. The client device further includes configuration logic to transition the client device, based on the comparison, from the first operational mode to a second operational mode corresponding to a second AV coding scheme, wherein only one of the first AV coding scheme and the second AV coding scheme supports a video scalability feature, and wherein the communication logic to receive a second portion of the AV stream data based on the second operational mode of the client device.

In an embodiment, the client device further comprising second mode logic to determine, based on a difference between a first quality of the first portion and a second quality of the second portion, whether to download first AV data. In another embodiment, the first encoding scheme supports the video scalability feature, wherein the comparison indicates a stability of the network. In another embodiment, the second encoding scheme supports the video scalability feature, wherein the comparison indicates an instability of the network.

Techniques and architectures for streaming audio-video information are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

1-25. (canceled)

26. A device comprising:
communication logic to receive a first portion of an audio-video (AV) stream via a network during a first operational mode of the device, the first operational mode corresponding to a first AV coding scheme;
detection logic to perform a comparison of a stability state of the network to a first threshold during the first operational mode; and
configuration logic to transition the device, based on the comparison, from the first operational mode to a second operational mode corresponding to a second AV coding scheme, wherein only one of the first AV coding scheme and the second AV coding scheme supports a video scalability feature;
the communication logic further to receive a second portion of the AV stream data based on the second operational mode of the device.

27. The device of claim 26, further comprising second mode logic to determine, based on a difference between a first quality of the first portion and a second quality of the second portion, whether to download first AV data.

28. The device of claim 27, wherein the second encoding scheme supports the video scalability feature and wherein the second mode logic determines to download the first AV data to enhance the second portion.

29. The device of claim 27, wherein the first encoding scheme supports the video scalability feature and wherein the second mode logic determines to download the first AV data as an alternative to the second portion.

30. The device of claim 26, wherein the first encoding scheme supports the video scalability feature, and wherein the comparison indicates a stability of the network.

31. The device of claim 30, wherein the first threshold includes a minimum period of time during which any change to a bandwidth of the network is an increase.

32. The device of claim 26, wherein the second encoding scheme supports the video scalability feature, and wherein the comparison indicates an instability of the network.

33. The device of claim 32, wherein the first threshold includes a maximum rate of decrease of a bandwidth of the network.

34. The device of claim 32, wherein the first threshold includes a minimum level of a bandwidth of the network.

35. The device of claim 26, wherein the one of the first AV coding scheme and the second AV coding scheme is a scalable video coding scheme.

36. A method at a communication device, the method comprising:
receiving a first portion of an audio-video (AV) stream via a network during a first operational mode of the communication device, the first operational mode corresponding to a first AV coding scheme;
during the first operational mode, comparing a stability state of the network to a first threshold;
based on the comparing the stability state to the first threshold, transitioning the communication device from the first operational mode to a second operational mode corresponding to a second AV coding scheme, wherein only one of the first AV coding scheme and the second AV coding scheme supports a video scalability feature; and
receiving a second portion of the AV stream data during the second operational mode of the communication device.

37. The method of claim 36, further comprising:
during the second operational mode, detecting whether a difference between a first quality of the first portion and a second quality of the second portion exceeds a second threshold, and
based on the detecting whether the difference exceeds the second threshold, determining whether to download first AV data.

38. The method of claim 37, wherein the first AV data represents an AV frame which is also represented by one of the first portion and the second portion.

39. The method of claim 37, wherein the second encoding scheme supports the video scalability feature, the method further comprising downloading the first AV data to enhance the second portion.

40. The method of claim 37, wherein the first encoding scheme supports the video scalability feature, the method further comprising downloading the first AV data as an alternative to the second portion.

41. The method of claim 36, wherein the first encoding scheme supports the video scalability feature, and wherein the comparing the stability state to the first threshold indicates a stability of the network.

42. The method of claim 41, wherein the first threshold includes a minimum period of time during which any change to a bandwidth of the network is an increase.

43. The method of claim 36, wherein the second encoding scheme supports the video scalability feature, and wherein the comparing the stability state to the first threshold indicates an instability of the network.

44. The method of claim 43, wherein the first threshold includes a maximum rate of decrease of a bandwidth of the network.

45. The method of claim 43, wherein the first threshold includes a minimum level of a bandwidth of the network.

46. A computer-readable storage medium having stored thereon instructions which, when executed by one or more processing units, cause the one or more processing units to perform a method comprising:
receiving a first portion of an audio-video (AV) stream via a network during a first operational mode of a computer platform, the first operational mode corresponding to a first AV coding scheme;
during the first operational mode, comparing a stability state of the network to a first threshold;
based on the comparing the stability state to the first threshold, transitioning the computer platform from the first operational mode to a second operational mode corresponding to a second AV coding scheme, wherein only one of the first AV coding scheme and the second AV coding scheme supports a video scalability feature; and
receiving a second portion of the AV stream data during the second operational mode of the computer platform.

47. The computer-readable storage medium of claim 46, the method further comprising:
during the second operational mode, detecting whether a difference between a first quality of the first portion and a second quality of the second portion exceeds a second threshold, and
based on the detecting whether the difference exceeds the second threshold, determining whether to download first AV data.

48. The computer-readable storage medium of claim 46, wherein the first encoding scheme supports the video scalability feature, and wherein the comparing the stability state to the first threshold indicates a stability of the network.

49. The computer-readable storage medium of claim 46, wherein the second encoding scheme supports the video scalability feature, and wherein the comparing the stability state to the first threshold indicates an instability of the network.

50. The computer-readable storage medium of claim 46, wherein the one of the first AV coding scheme and the second AV coding scheme is a scalable video coding scheme.
